(19) United States
(12) Patent Application Publication
(10) Pub. No.: US 2012/0290998 A1
(43) Pub. Date: Nov. 15, 2012

(54) DEVICE PERFORMANCE PREDICTION METHOD AND DEVICE STRUCTURE OPTIMIZATION METHOD

(75) Inventors: Qingqing Liang, Lagrangeville, NY (US); Huilong Zhu, Poughkeepsie, NY (US); Huicai Zhong, San Jose, CA (US); Meng Li, Beijing (CN)

(73) Assignee: Institute of Microelectronics, Chinese Academy of Sciences, Beijing (CN)

(21) Appl. No.: 13/320,291

(22) PCT Filed: Apr. 26, 2011
(86) PCT No.: PCT/CN2011/073305

§ 371 Date: Nov. 14, 2011

(30) Foreign Application Priority Data
Jan. 12, 2011 (CN) 201110005923.2

(51) Int. Cl. G06F 17/50

(52) U.S. Cl. 716/132; 716/136

(57) ABSTRACT

The present application discloses a device performance prediction method and a device structure optimization method. According to an embodiment of the present invention, a set of structural parameters and/or process parameters for a semiconductor device constitutes a parameter point in a parameter space, and a behavioral model library is established with respect to a plurality of discrete predetermined parameter points in the parameter space, and the predetermined parameter points being associated with their respective performance indicator values in the behavioral model library. The device performance prediction method comprises: inputting a parameter point, called “predicting point”, whose performance indicator value is to be predicted; and if the predicting point has a corresponding record in the behavioral model library, outputting the corresponding performance indicator value as a predicted performance indicator value of the predicting point, or otherwise if there is no record corresponding to the predicting point in the behavioral model library, calculating a predicted performance indicator value of the predicting point by interpolation based on Delaunay triangulation.

The present application claims priority to Chinese Application No. 201110005923.2, filed on Jan. 12, 2011, entitled “device performance prediction method and device structure optimization method”, the entire disclosure of which is incorporated herein by reference.

### FIELD OF THE INVENTION

The present invention relates to the field of semiconductor devices, and particularly, to a performance prediction method for a semiconductor device and a structure optimization method for a semiconductor device.

### BACKGROUND OF THE INVENTION

is For a semiconductor device, various structural parameters and/or process parameters would affect its operation performance. However, it is difficult to establish an analytic function relationship between those parameters and the device performance. Therefore, in designing the semiconductor device, for a particular parameter design, it is hard to know the performance of the semiconductor device in advance before it is manufactured according to the design, and thus, it is difficult to efficiently determine whether the design is good or not.

In view of the above, there is a need for a novel method for predicting the performance of the semiconductor device or for optimizing the design of the semiconductor device, so as to obtain an optimized design which can achieve optimal performance.

### SUMMARY OF THE INVENTION

An object of the present invention is to provide a performance prediction method for a semiconductor device and a structure optimization method for a semiconductor device.

According to an aspect of the present invention, there is provided a performance prediction method for a semiconductor device, a set of structural parameters and/or process parameters for the semiconductor device constituting a parameter point in a parameter space, a behavioral model library being established with respect to a plurality of discrete predetermined parameter points in the parameter space, and the predetermined parameter points being associated with their respective performance indicator values in the behavioral model library, the method comprising: inputting a parameter point, called “predicting point”, whose performance indicator value is to be predicted; and searching the behavioral model library for the predicting point, wherein if the predicting point corresponds to a predetermined parameter point in the behavioral model library, then a performance indicator value associated with this predetermined parameter point is output as a predicted performance indicator value of the predicting point, or otherwise if the predicting point does not correspond to any predetermined parameter point in the behavioral model library, then a Delaunay triangulation operation is carried out on the predetermined parameter points in the behavioral model library, and an interpolation operation is performed based on the result of the Delaunay triangulation operation to calculate a predicted performance indicator value of the predicting point.

Preferably, the Delaunay triangulation operation results in Delaunay triangulation cells, and the interpolation operation is performed based on parameter points at respective vertices of a Delaunay triangulation cell within which the predicting point is positioned. Here, the Delaunay triangulation cells are in the form of triangle in a 2-dimensional parameter space, and in the form of tetrahedron in a 3-dimensional parameter space.

Preferably, if the predicting point is positioned outside all the Delaunay triangulation cells, a space transfer operation is carried out on the parameter space so that the predicting point is positioned within a new Delaunay triangulation cell in the transferred space. The space transfer operation may comprise: transferring the parameter space from the Euclidean coordinates to the Hyperspherical coordinates; reversing the radius in the Hyperspherical coordinates; and transferring the Hyperspherical coordinates back to the Euclidean coordinates.

Preferably, the set of structural parameters and/or process parameters may comprise a gate length, a threshold voltage, a parasitic resistance, and/or a gate dielectric thickness.

Preferably, the behavioral model library may be established through a device simulation and/or a real hardware measurement.

Preferably, the performance indicator may comprise an electrical property of the semiconductor device.

Preferably, the semiconductor device may comprise a static random access memory, and the performance indicator may comprise a yield.

According to a further aspect of the present invention, there is provided a structure optimization method for a semiconductor device, comprising: determining a plurality of sets of structural parameters and/or process parameters for the semiconductor device; for each of the plurality of sets of structural parameters and/or process parameters, predicting a performance indicator value corresponding to the set of structural parameters and/or process parameters by the above method; based on an optimal performance indicator value among the respective performance indicator values corresponding to the plurality of sets of structural parameters and/or process parameters, determining a set of structural parameters and/or process parameters corresponding to the optimal performance indicator value; and setting a final physical structure for the semiconductor device based on the determined set of structural parameters and/or process parameters.

According to embodiments of the present invention, it is possible to effectively analyze a complex multi-variable (multi-parameter) system such as a semiconductor device by utilizing an established behavioral model library, and thus to predict the performance indicator (e.g. the yield of a SRAM) of the semiconductor device at the process level.

### BRIEF DESCRIPTION OF THE DRAWINGS

The above and other objects, features, and advantages of the present invention will become apparent from the following descriptions on embodiments of the present invention with reference to the drawings, in which:

FIG. 1 is a schematic flow chart showing a device performance prediction method according to an embodiment of the present invention;

FIG. 2 is a schematic flow chart showing an interpolation operation according to an embodiment of the present invention;

FIG. 3 is a schematic flow chart showing a device structure optimization method according to an embodiment of the present invention;

FIG. 4 shows an example of Delaunay triangulation according to an embodiment of the present invention;

FIG. 5 shows an example of interpolation in a case where a predicting point is positioned inside a triangle obtained through Delaunay triangulation according to an embodiment of the present invention;

FIG. 6 shows an example where a predicting point is positioned outside triangles obtained through Delaunay triangulation according to an embodiment of the present invention;

FIG. 7 shows an example of a space transfer operation according to an embodiment of the present invention;

FIG. 8 is an enlarged view of a portion of FIG. 7 showing an example of interpolation after the space transfer operation;

FIG. 9 shows an example of selecting points for interpolation in a case where a predicting point is positioned outside triangles obtained through Delaunay triangulation according to an embodiment of the present invention;

FIG. 10 shows a Schmoo-chart simulation example of SRAM cells according to an embodiment of the present invention; and

FIG. 11 shows an example of optimizing the design of a SRAM according to an embodiment of the present invention.

### DETAILED DESCRIPTION OF THE PREFERRED EMBODIMENTS

Hereinafter, the present invention is described with reference to embodiments shown in the attached drawings. However, it is to be understood that those descriptions are just provided for illustrative purpose, rather than limiting the present invention. Further, in the following, descriptions of known structures and techniques are omitted so as not to unnecessarily obscure the concept of the present invention.

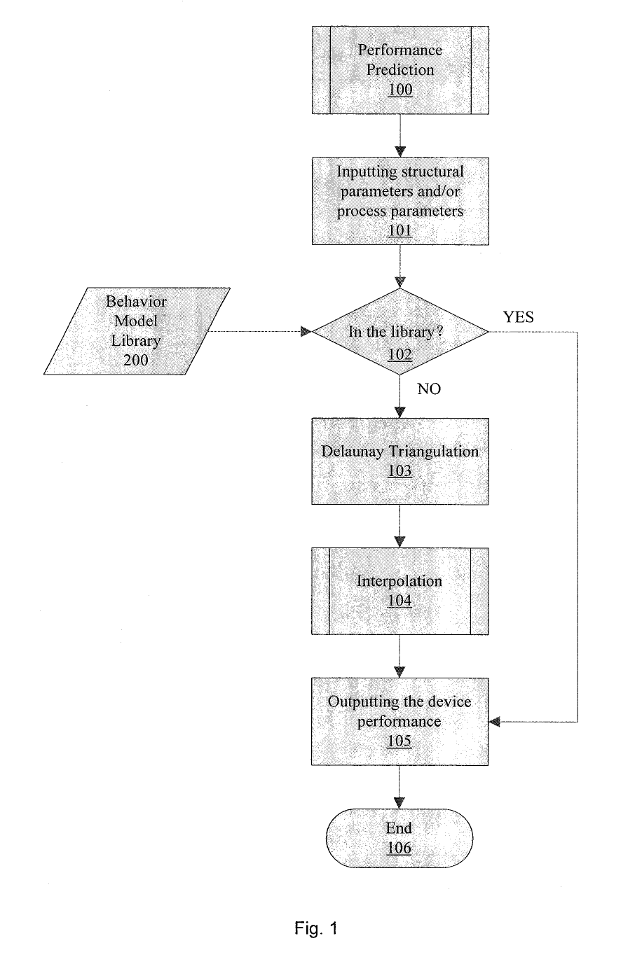

FIG. 1 is a schematic flow chart showing a device performance prediction method according to an embodiment of the present invention.

As shown in FIG. 1, the device performance prediction method 100 according to this embodiment starts with step 101, where a set of structural parameters and/or process parameters for the device is input. For example, this parameter set may be one selected in designing the device, and may comprise one or more parameters among various structural/process parameters, such as gate length, threshold voltage, parasitic resistance and gate dielectric thickness, which may affect the performance of the resulting semiconductor device.

Next, in step 102, it is determined whether the input set of structural parameters and/or process parameters exists in a behavioral model library for the semiconductor device. Here, the so-called “behavioral model library” refers to associated sets of structural parameters and/or process parameters with their corresponding performance indicator values. For example, such sets may be implemented as a look-up table.

Here, the “performance indicator” may comprise various electrical properties of the device, such as current and/or voltage properties, which can characterize the device performance. For example, the performance indicator may comprise only one single physical parameter, and thus the “performance indicator value” may represent an actual value of this single physical parameter. Alternatively, the performance indicator may comprise more than one physical parameter, and thus the “performance indicator value” may represent a weighted sum of those physical parameters. Optionally, each of the physical parameters included in the “performance indicator” may be “scored.” For example, for a physical parameter having a value which achieves an optimal performance, it is scored as 100%; and for a physical parameter having a value which achieves an inferior performance, it is scored as being smaller than 100%. Then, the “performance indicator value” may be obtained by summing the scores for the respective physical parameters.

For example, such a behavioral model library may be established as follows. A real semiconductor device having a particular parameter set (having a particular gate length, a particular threshold voltage, and a particular gate dielectric thickness, for example) may be tested for its corresponding performance indicator value, and thus an association between the particular parameter set and the performance indicator value can be obtained. Alternatively, the semiconductor device may be subjected to a simulation with respect to a particular parameter set (for example, under conditions of a particular gate length, a particular threshold voltage, a particular gate dielectric thickness, etc.), and thus an association between the particular parameter set and the performance indicator value can be obtained. Then, the association between the particular parameter set and the performance indicator value is stored (in the form of “look-up table”, for example), to establish the behavioral model library.

is Here, such a “parameter set” may be considered as a discrete “(parameter) point” in a parameter space. The parameter space may be a multidimensional space, wherein each of the structural parameters and/or process parameters included in the parameter set constitutes a respective dimension. And the “performance indicator value” may be considered as a function value corresponding to this discrete “(parameter) point”.

For example, a behavioral model library may be established with respect to parameters at predetermined intervals (for example, gate lengths at predetermined intervals, threshold voltages at predetermined intervals, and gate dielectric thicknesses at predetermined intervals), that is, some points spaced by predetermined intervals in the parameter space are based on, to establish a behavioral model library covering a certain parameter range (i.e. covering a certain volume in the parameter space). For example, the parameters may be spaced by a constant interval. The “parameter range” may be a possible range for a specific manufacture process such as the 22 nm process, for example. Thus, a common behavioral model library can be obtained for a certain manufacture process. Therefore, when designing devices under the manufacture process, it is possible to utilize the common behavioral model library for performance prediction and design optimization.

If the determination result in step 102 is “YES”, i.e. if the input set of structural parameters and/or process parameters has a corresponding record in the behavioral model library, a device performance indicator value corresponding to this input set of structural parameters and/or process parameters is retrieved from the behavioral model library. Therefore, the method directly proceeds to step 105 to output the corresponding device performance indicator value.

If the determination result in step 102 is “NO”, i.e. if the input set of structural parameters and/or process parameters has no corresponding record in the behavioral model library, a corresponding device parameter indicator value may be calculated through interpolation. An important feature of the present invention consists in that parameter points used in the interpolation are selected from the model library based on Delaunay triangulation. Specifically, a Delaunay triangulation operation is carried out on the parameter points in the model library, and parameter points positioned at vertices of a Delaunay triangulation cell (a triangle in a 2-dimensional space, a tetrahedron in a 3-dimensional space, and so on) are selected for the interpolation.

Specifically, in step 103, a Delaunay triangulation operation is carried out on all measured parameter points in the parameter space (i.e. parameter points included in the behavioral model library). The Delaunay triangulation operation per se is well known to those skilled in the art, by which it is possible to divide a multidimensional space into some discrete cells having the measured parameter points as vertices. Here, detailed descriptions of the Delaunay triangulation operation are omitted.

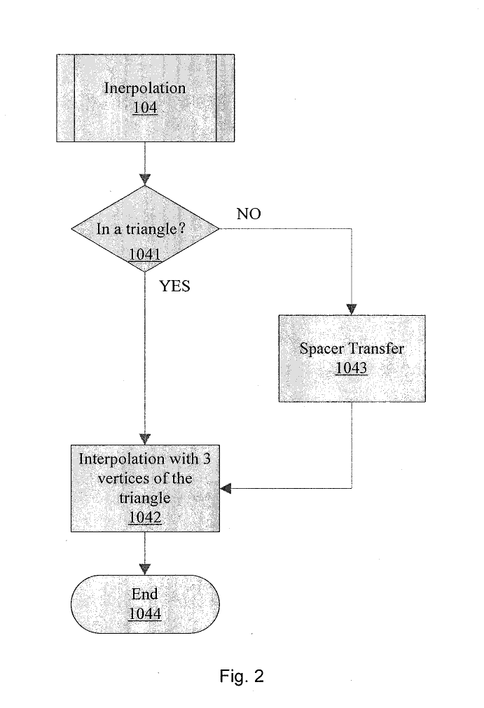

Then, in step 104, an interpolation operation is carried out based on the result of the Delaunay triangulation operation. Hereinafter, this interpolation operation will be described in more detail with reference to FIG. 2.

A device performance indicator value corresponding to the input set of structural parameters and/or process parameters (a parameter point) is obtained through the interpolation operation of step 104. Therefore, in step 105, the obtained device performance indicator value is output.

Thus, for the input set of structural parameters and/or process parameters (i.e. a point in the parameter space, which is also referred to as “predicting point” hereinafter), the corresponding device performance (i.e. the function value at the predicting point) is obtained. In other words, the performance prediction or evaluation is achieved with respect to this parameter point. Then, the method is ended in step 106.

In the following, an example of the interpolation operation according to an embodiment of the present invention is described in detail with reference to FIG. 2. As shown in FIG. 2, in the interpolation step 104, firstly, it is determined whether the parameter point is positioned within a Delaunay triangulation cell, which is obtained through the Delaunay triangulation operation, in the parameter space or not in sub step 1041.

If the determination result in sub step 1041 is “YES”, in sub step 1042, the parameter points at vertices of the Delaunay triangulation cell (e.g. three vertices of a triangle cell in a 2-dimenstional parameter space, four vertices of a tetrahedron cell in a 3-dimensional parameter space, and so on), within which the predicting point is positioned, are adopted in the interpolation operation. The interpolation operation may comprise a linear interpolation operation, for example, with respect to the predicting point.

If the determination result in sub step 1041 is “NO”, in sub step 1043, a space transfer operation may be carried out to make the predicting point locate inside a new Delaunay triangulation cell in the transferred space after the space transfer operation. For example, such a space transfer operation may comprise transferring the parameter space from the Euclidean coordinates to the Hyperspherical coordinates or other space coordinates, reversing the radius in the transferred Hyperspherical coordinates or other space coordinates, and then transferring back to the Euclidean coordinates.

Thus, after the space transfer operation in sub step 1043, in sub step 1042, the parameter points at vertices of a Delaunay triangulation cell, within which the predicting point is positioned, in the transferred space are adopted for the interpolation operation.

Eventually, an interpolated function value (i.e. the performance indicator value) at the predicting point is obtained. Then, the interpolation operation is ended in sub step 1044.

Hereinafter, the above device performance prediction method is explained in conjunction with a specific example, so that those skilled in the art will better understand the present invention.

In the following description, it is assumed that the parameter set comprises two parameters, that is, the parameter space is a 2-dimensional space, for convenience of description and concision of illumination. Here, those two parameters may comprise a gate-source voltage (Vgs) and a drain-source voltage (Vds), for example. It should be noted that the present invention is not limited thereto. In fact, the parameter space may have more than two dimensions, or may have only one dimension. Further, the parameters are not limited to the gate-source voltage (Vgs) or the drain-source voltage (Vds).

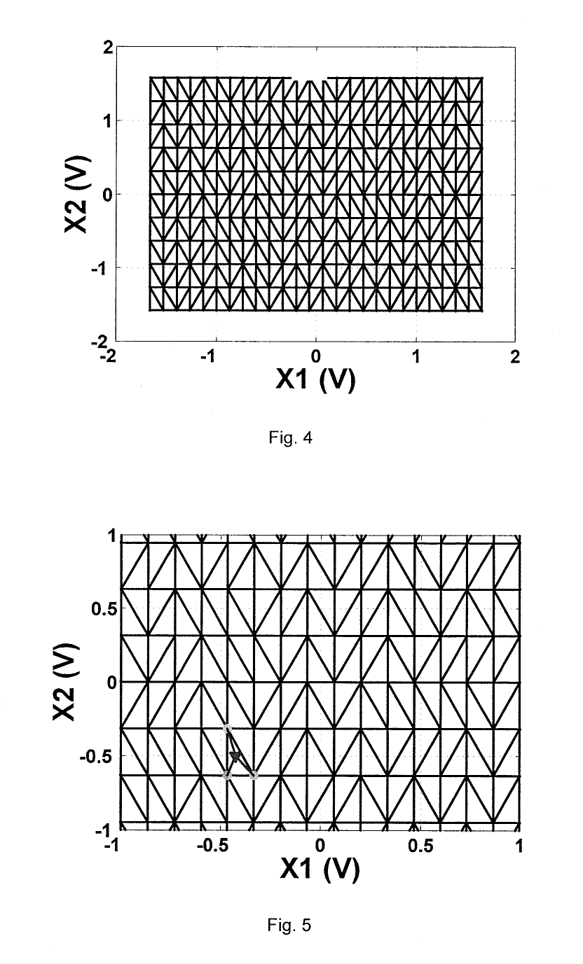

A behavioral model library is established for a certain volume of the parameter space (when the parameter space is 2-dimensional, the behavioral model library is established for a certain “area” of the parameter space). FIG. 4 shows parameter points in such a behavioral model library. As shown in FIG. 4, each parameter point (X1, X2) (where X1 indicates Vgs and X2 indicates Vds, for example) has a corresponding function value (i.e. a performance indicator value, such as gate current, source current, drain current, and the like). In FIG. 4, only the parameter points (X1, X2) (i.e. vertices of the triangles shown in the drawing) are shown, but their associated function values are not shown. Here, it is shown that the parameter points (X1, X2) are spaced at even intervals in both of the X1 direction and the X2 direction. However, the present invention is not limited to such an embodiment, though such even intervals are advantageous for calculation.

In FIG. 4, the result of the Delaunay triangulation operation on those parameter points (X1, X2) included in the behavioral model library is also shown. Specifically, the triangles shown in FIG. 4 are all Delaunay triangulation cells, in the form of triangle, obtained through the Delaunay triangulation operation.

FIG. 5 shows a subset of the behavioral model library shown in FIG. 4. In FIG. 5, a parameter point whose function value is to be predicted, that is, a predicting point, is also shown by a solid triangular mark. It can be seen that this predicting point is positioned within a Delaunay triangle. According to one embodiment of the present invention, when the predicting point is positioned within the Delaunay triangle, the function value at this predicting point may be calculated through an interpolation operation based on the function values corresponding to the parameter points at the three vertices of the Delaunay triangle. For example, the interpolation operation may comprise a linear interpolation operation.

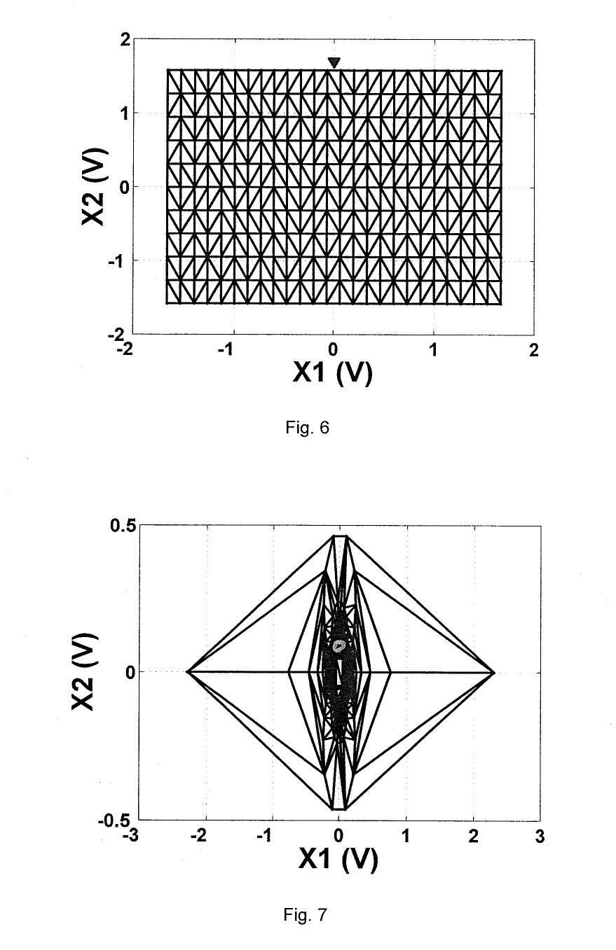

If a predicting point is positioned outside all of the Delaunay triangles, as shown by a solid triangular mark in FIG. 6, it is necessary to transfer the parameter space (i.e. the space where the parameter points (X1, X2) exist) to make the predicting point inside a newly extracted Delaunay triangle after the transfer operation, so that it is possible to select parameter points for the interpolation operation.

FIG. 7 shows an example of the space transfer operation. In this example, the parameter space is transferred from the Euclidean coordinates to the to Hyperspherical coordinates (the polar coordinates in a 2-dimensional space, and the spherical coordinates in a 3-dimensional space). In the Hyperspherical coordinates, the radius (a non-negative real number) of each point is reversed (that is, a reciprocal of the radius is assumed). Then, the Hyperspherical coordinates is transferred back to the Euclidean coordinates. FIG. 7 shows the resultant parameter points in the behavioral model library and the predicting point, which are previously shown in FIG. 6, after they are subjected to the above processpredicting point.

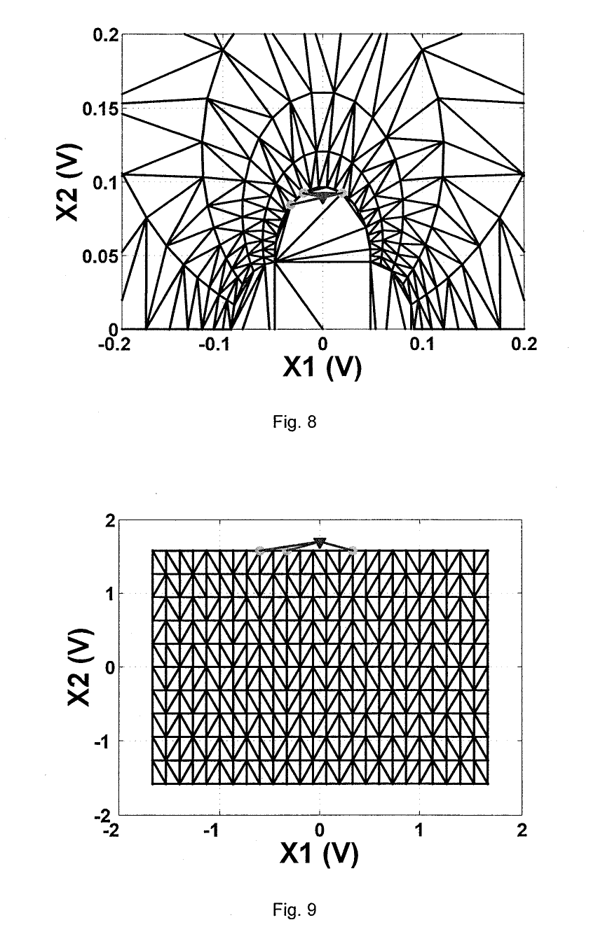

FIG. 8 is an enlarged view showing the region in FIG. 7 near the predicting point. It can be seen clearly from FIG. 8 that now the predicting point (indicated by the solid triangular mark) is positioned within a new Delaunay triangle after the above process. Thus, the function value at the predicting point may be calculated through an interpolation operation, e.g. a linear interpolation operation, based on the function values corresponding to the parameter points at the three vertices of this triangle. FIG. 9 shows actual positions of the three parameter points used in the interpolation operation in the previous parameter space before being transferred.

In the above, the example of how to calculate a function value at a predicting point through interpolation based on parameter points in a behavioral model library is described. According to another embodiment of the present invention, the above device performance prediction method may be applied to optimize a semiconductor device design.

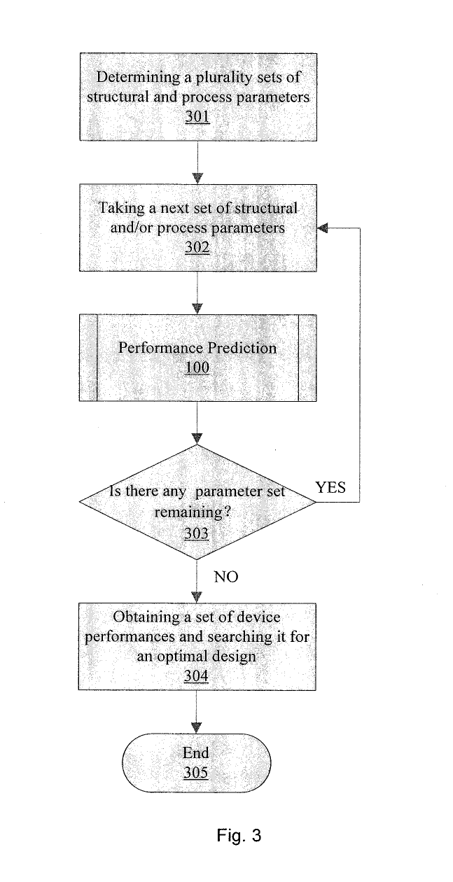

FIG. 3 is a schematic flow chart showing a device structure optimization method according to an embodiment of the present invention.

As shown in FIG. 3, in step 301, a designer firstly determines a structural design proposal, which, for example, includes a plurality of alternative sets of structural parameters and/or process parameters (i.e. a plurality of designed “parameter points” or a plurality of “predicting points”).

Then, in step 302, one of the determined plurality of predicting points is selected for performance prediction. Specifically, the function value (i.e. the performance indicator value) at this predicting point is predicted according to the above described performance prediction flow 100. Here, detailed descriptions on the specific steps of the performance prediction flow are omitted, for which one may refer to the afore-mentioned descriptions.

After the performance indicator value at this predicting point is obtained through the performance prediction flow 100, in step 303, it is determined whether there is a further predicting point or not. If the determination result is “YES”, that is, if there is still a further predicting point, the method returns to step 302 where the further predicting point is subjected to the performance prediction. If the determination result is “NO”, that is, if all of the predicting points have been subjected to the performance prediction, then in step 304, a set of device performance indicator values corresponding to all of the predicting points is obtained.

An optimal design can be achieved based on the set of device performance indicator values. For example, the optimal design may be obtained by searching the set of device performance indicator values for an optimal performance indicator value, which corresponds to a predicting point, and selecting the parameters corresponding to this predicting point as the final design parameters. Then, the method is ended in step 305.

It is possible to form a semiconductor device whose structure is optimized by manufacturing this semiconductor device according to the optimal design.

Hereinafter, an application example of the present invention is explained in to conjunction with a Static Random Access Memory (SRAM).

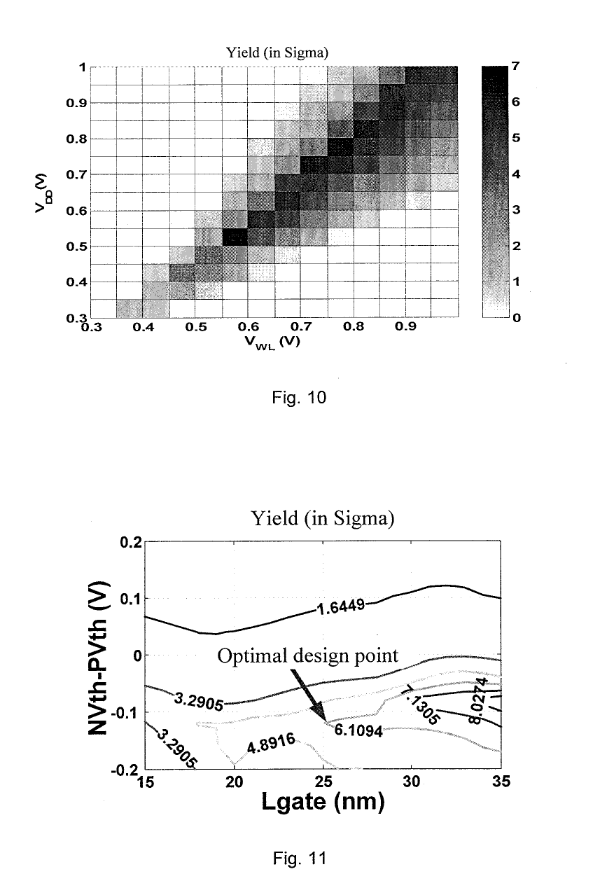

FIG. 10 is a Schmoo chart showing a result of predicting performance indicators for a SRAM, here “yield”, in a parameter space of VWL (word line bias voltage)−VDD (bit line bias voltage). Each point in this chart corresponds to a specific parameter set (VWL, VDD) (i.e. a parameter point), and the function value (i.e. the performance indicator value, here the yield) at a parameter point is indicated by a gray level. On the right side of this chart, actual yields corresponding to the respective gray levels are shown. Here, the yields are measured in sigmas approximately in a Gaussian distribution. For example, the yield corresponding to 3 sigma is 99.73%.

Some parameter points (as well as their associated performance indicator values) in the parameter space shown in FIG. 10 set a behavioral model library. In other words, the discrete performance indicator values (e.g. electrical properties of the device such as current and voltage properties) corresponding to those parameter points are obtained through real hardware measurement or device simulations. And the other parameter points (not the tested ones) are predicted based on the behavioral model library by the above described method according to the present invention.

It can be seen that a parameter point (VWL, VDD) which can achieve the optimal performance (here, the optimal yield) can be easily selected based on the Schmoo chart shown in FIG. 10. For example, in the Schmoo chart shown in FIG. 10, a parameter point near (0.6, 0.5) (that is, VWL is 0.6V and VDD is 0.5V) can achieve the optimal yield.

FIG. 11 is a design optimization chart showing a result of predicting a performance indicator of a SRAM, here “yield”, in a parameter space of Lgate (gate length)−(NVth−PVth) (“NVth−PVth” represents a difference between threshold voltages of NFETs and PFETs, and is an important parameter in the CMOS process). Each point in this chart corresponds to a specific parameter set (Lgate, (NVt−PVth)) (i.e. a parameter point), and contour lines of the function values (i.e. the performance indicator values, here the yields) at the respective parameter points are shown. Specifically, the parameter points on each of the contour lines have the same function value (i.e. the same yield). On each of the contour lines, the actual yield (in sigma) represented by this contour line is indicated.

Some parameter points (as well as their associated performance indicator values) in the parameter space shown in FIG. 11 constitute a behavioral model library. In other words, the performance indicator values (here the yields) corresponding to those parameter points are obtained through real hardware measurement or device simulations. And the other parameter points (not the tested ones) are predicted based on the behavioral model library by the above described method according to the present invention. Further, each of the contour lines shown in the drawing is obtained by connecting the parameter points having the same function value.

Based on the chart shown in FIG. 11, an optimal design point can be easily selected, as shown by the arrow in the drawing. According to this optimal design point, it is possible to manufacture a semiconductor device with optimized structure (by setting its gate length as 25 nm, for example).

Although the application of the present invention is explained in the above with reference to the yield of the SRAM, the present invention is not limited to such an embodiment. It is to be understood by those skilled in the art that the present invention can apply to various multi-port (or multi-variable) systems.

In the above description, details of patterning and etching of the respective layers are not provided. It is to be understood by those skilled in the art that various means in the prior art may be utilized to form the layers and regions in desired shapes. Further, to achieve the same feature, those skilled can devise different methods than those described above. The fact that the respective embodiments are described separately in the above does not mean that advantageous features recited in those embodiments cannot be used in combination.

The present invention is described above with reference to the embodiments thereof. However, those embodiments are provided just for illustrative purpose, rather than limiting the present invention. The scope of the invention is defined by the attached claims as well as equivalents thereof. Those skilled in the art can make various alternations and modifications without departing from the scope of the invention, which all fall into the scope of the invention.

1. A performance prediction method for a semiconductor device, a set of structural parameters and/or process parameters for the semiconductor device constituting a parameter point in a parameter space, a behavioral model library being established with respect to a plurality of discrete predetermined parameter points in the parameter space, and the predetermined parameter points being associated with their respective performance indicator values in the behavioral model library, the method comprising:
inputting a parameter point, called “predicting point”, whose performance indicator value is to be predicted; and
searching the behavioral model library for the predicting point, wherein
if the predicting point corresponds to a predetermined parameter point in the behavioral model library, then a performance indicator value associated with this predetermined parameter point is output as a predicted performance indicator value of the predicting point, or otherwise
if the predicting point does not correspond to any predetermined parameter point in the behavioral model library, then a Delaunay triangulation operation is carried out on the predetermined parameter points in the behavioral model library, and an interpolation operation is performed based on the result of the Delaunay triangulation operation to calculate a predicted performance indicator value of the predicting point.

2. The method according to claim 1, wherein the Delaunay triangulation operation results in Delaunay triangulation cells, and
the interpolation operation is performed based on parameter points at respective vertices of a Delaunay triangulation cell within which the predicting point is positioned.

3. The method according to claim 2, wherein the Delaunay triangulation cells are in the form of triangle in a 2-dimensional parameter space, and in the form of tetrahedron in a 3-dimensional parameter space.

4. The method according to claim 2, wherein if the predicting point is positioned outside all the Delaunay triangulation cells, a space transfer operation is carried out on the parameter space so that the predicting point is positioned within a new Delaunay triangulation cell in the transferred space.

5. The method according to claim 4, wherein the space transfer operation comprises:
transferring the parameter space from the Euclidean coordinates to the Hyperspherical coordinates;
reversing the radius in the Hyperspherical coordinates; and
transferring the Hyperspherical coordinates back to the Euclidean coordinates.

6. The method according to claim 1, wherein the set of structural parameters and/or process parameters comprises a gate length, a threshold voltage, a parasitic resistance, and/or a gate dielectric thickness.

7. The method according to claim 1, wherein the behavioral model library is established through a device simulation and/or a real hardware measurement.

8. The method according to claim 1, wherein the performance indicator comprises an electrical property of the semiconductor device.

9. The method according to claim 1, wherein the semiconductor device comprises a static random access memory, and the performance indicator comprises a yield.

10. A structure optimization method for a semiconductor device, comprising:
determining a plurality of sets of structural parameters and/or process parameters for the semiconductor device;
for each of the plurality of sets of structural parameters and/or process parameters, predicting a performance indicator value corresponding to the set of structural parameters and/or process parameters by the method according to claim 1;
based on an optimal performance indicator value among the respective performance indicator values corresponding to the plurality of sets of structural parameters and/or process parameters, determining a set of structural parameters and/or process parameters corresponding to the optimal performance indicator value; and
setting a final physical structure for the semiconductor device based on the determined set of structural parameters and/or process parameters.

11. A structure optimization method for a semiconductor device, comprising:
determining a plurality of sets of structural parameters and/or process parameters for the semiconductor device;
for each of the plurality of sets of structural parameters and/or process parameters, predicting a performance indicator value corresponding to the set of structural parameters and/or process parameters by the method according to claim 2;
based on an optimal performance indicator value among the respective performance indicator values corresponding to the plurality of sets of structural parameters and/or process parameters, determining a set of structural parameters and/or process parameters corresponding to the optimal performance indicator value; and
setting a final physical structure for the semiconductor device based on the determined set of structural parameters and/or process parameters.

12. A structure optimization method for a semiconductor device, comprising:
determining a plurality of sets of structural parameters and/or process parameters for the semiconductor device;
for each of the plurality of sets of structural parameters and/or process parameters, predicting a performance indicator value corresponding to the set of structural parameters and/or process parameters by the method according to claim 3;
based on an optimal performance indicator value among the respective performance indicator values corresponding to the plurality of sets of structural parameters and/or process parameters, determining a set of structural parameters and/or process parameters corresponding to the optimal performance indicator value; and
setting a final physical structure for the semiconductor device based on the determined set of structural parameters and/or process parameters.

13. A structure optimization method for a semiconductor device, comprising:
determining a plurality of sets of structural parameters and/or process parameters for the semiconductor device;
for each of the plurality of sets of structural parameters and/or process parameters, predicting a performance indicator value corresponding to the set of structural parameters and/or process parameters by the method according to claim 4;
based on an optimal performance indicator value among the respective performance indicator values corresponding to the plurality of sets of structural parameters and/or process parameters, determining a set of structural parameters and/or process parameters corresponding to the optimal performance indicator value; and
setting a final physical structure for the semiconductor device based on the determined set of structural parameters and/or process parameters.

14. A structure optimization method for a semiconductor device, comprising:
determining a plurality of sets of structural parameters and/or process parameters for the semiconductor device;
for each of the plurality of sets of structural parameters and/or process parameters, predicting a performance indicator value corresponding to the set of structural parameters and/or process parameters by the method according to claim 5;
based on an optimal performance indicator value among the respective performance indicator values corresponding to the plurality of sets of structural parameters and/or process parameters, determining a set of structural parameters and/or process parameters corresponding to the optimal performance indicator value; and
setting a final physical structure for the semiconductor device based on the determined set of structural parameters and/or process parameters.

15. A structure optimization method for a semiconductor device, comprising:
determining a plurality of sets of structural parameters and/or process parameters for the semiconductor device;
for each of the plurality of sets of structural parameters and/or process parameters, predicting a performance indicator value corresponding to the set of structural parameters and/or process parameters by the method according to claim 6;
based on an optimal performance indicator value among the respective performance indicator values corresponding to the plurality of sets of structural parameters and/or process parameters, determining a set of structural parameters and/or process parameters corresponding to the optimal performance indicator value; and
setting a final physical structure for the semiconductor device based on the determined set of structural parameters and/or process parameters.

16. A structure optimization method for a semiconductor device, comprising:
determining a plurality of sets of structural parameters and/or process parameters for the semiconductor device;
for each of the plurality of sets of structural parameters and/or process parameters, predicting a performance indicator value corresponding to the set of structural parameters and/or process parameters by the method according to claim 7;
based on an optimal performance indicator value among the respective performance indicator values corresponding to the plurality of sets of structural parameters and/or process parameters, determining a set of structural parameters and/or process parameters corresponding to the optimal performance indicator value; and
setting a final physical structure for the semiconductor device based on the determined set of structural parameters and/or process parameters.

17. A structure optimization method for a semiconductor device, comprising:
determining a plurality of sets of structural parameters and/or process parameters for the semiconductor device;
for each of the plurality of sets of structural parameters and/or process parameters, predicting a performance indicator value corresponding to the set of structural parameters and/or process parameters by the method according to claim 8;
based on an optimal performance indicator value among the respective performance indicator values corresponding to the plurality of sets of structural parameters and/or process parameters, determining a set of structural parameters and/or process parameters corresponding to the optimal performance indicator value; and
setting a final physical structure for the semiconductor device based on the determined set of structural parameters and/or process parameters.

18. A structure optimization method for a semiconductor device, comprising:
determining a plurality of sets of structural parameters and/or process parameters for the semiconductor device;
for each of the plurality of sets of structural parameters and/or process parameters, predicting a performance indicator value corresponding to the set of structural parameters and/or process parameters by the method according to claim 9;
based on an optimal performance indicator value among the respective performance indicator values corresponding to the plurality of sets of structural parameters and/or process parameters, determining a set of structural parameters and/or process parameters corresponding to the optimal performance indicator value; and
setting a final physical structure for the semiconductor device based on the determined set of structural parameters and/or process parameters.
